(19) United States
(12) Patent Application Publication
(10) Pub. No.: US 2004/0021908 A1
(43) Pub. Date: Feb. 5, 2004

(54) Method of automatically sending back communication record by email

(75) Inventor: Ko-Meng Chen, Hou Lung Jen (TW)

Correspondence Address: BROWDY AND NEIMARK, P.L.L.C., 624 NINTH STREET, NW, SUITE 300, WASHINGTON, DC, 20001-5303, US

(73) Assignee: Teco Image Systems Co., Ltd., Taipei (TW)

(21) Appl. No.: 10/211,322

(22) Filed: Aug. 5, 2002

(51) Int. Cl. G06F 15/00; H04N 1/00

(52) U.S. Cl. 358/402; 358/1.15

(57) ABSTRACT

A method of automatically sending back the communication record by email, wherein a document to be transmitted or received by a user is inputted into a communication device. Each piece of transmitted or received communication record is recorded in automatic sending back way like email, file transfer protocol (FTP), or fax. All the communication records are accumulated in table or list. This table or list will be text or converted from text into an electronic document or an image file, which is finally sent to a preset individual or several people for reference by email when a specific amount of pieces of records is achieved, when a specific time has arrived, or immediately. Thereby, the efficiency in management and use of the communication device can be enhanced.

### FIELD OF THE INVENTION

The present invention relates to a method of automatically sending back the communication record by email and, more particularly, to a method capable of automatically recording the communication record of a communication device and automatically sending this recorded table to a preset individual or several people for reference by email when a specific number of pieces of records is achieved, when a specific time has arrived, or immediately.

### BACKGROUND OF THE INVENTION

Existent communication devices like Internet-Faxes (I-Faxes) can transmit fax data by email on the Internet. They can be used by many users for transmission of image data by emails.

However, when in use, they can only print out each piece of communication record (including communication serial number, number of sheets, or time) to be transmitted or received by means of faxing, hence reducing their efficiency in management and use.

### SUMMARY OF THE INVENTION

Accordingly, the primary object of the present invention is to propose a method of automatically sending back the communication record by email so as to enhance the efficiency in management and use of a communication device.

To achieve the above object, in the present invention, a document to be transmitted or received by a user is inputted into a communication device. Each piece of transmitted or received communication record is recorded in automatic sending back way like email, file transfer protocol (FTP), or fax. All the communication records are accumulated in table or list. This table or list will be a text or be converted from text into an electronic document or an image file, which is finally sent to a preset individual or several people for reference by email when a specific number of pieces of records is achieved, when a specific time has arrived, or immediately.

The various objects and advantages of the present invention will be more. readily understood from the following detailed description when read in conjunction with the appended drawing, in which:

### BRIEF DESCRIPTION OF THE DRAWINGS

FIG. 1 is a flowchart of the present invention.

### DETAILED DESCRIPTION OF THE PREFERRED EMBODIMENTS

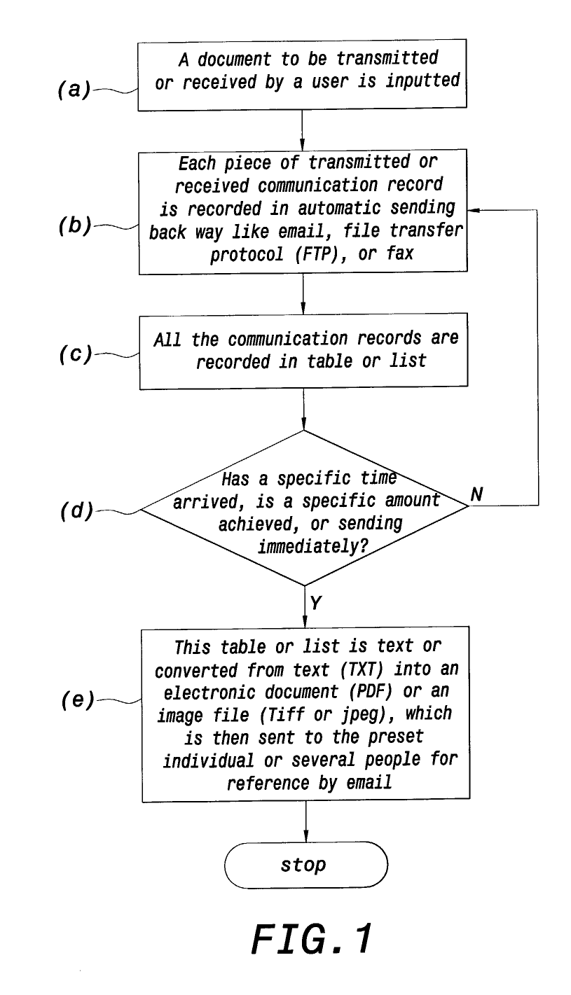

FIG. 1 shows a flowchart of the present invention, which is a method of automatically sending back the communication record of a communication device by email. The method comprises the following steps.

(a) A document to be transmitted or received by a user is inputted;

(b) Each piece of transmitted or received communication record is recorded in automatic sending back way like email, file transfer protocol (FTP), or fax. The communication record includes relevant data like communication serial number, sender, receiver, number of sheets, or time.

(c) All the communication records are recorded in table or list.

(d) Whether a specific time (e.g., 6 p.m. everyday) has arrived, whether a specific amount of pieces of records (e.g., 60 pieces of records) is achieved is judged or whether sending immediately.

(e) If the answer is positive, this table or list can be a text or be converted from text (TXT) into an electronic document (PDF) or an image file (Tiff or jpeg), which is then sent to the preset individual or several people for reference by email to finish the flowchart; otherwise, jump back to step (b).

Thereby, the efficiency in management and use of the communication device can be enhanced.

To sum up, the present invention is characterized in that all the communication records of a communication device can be automatically recorded in table or list, and this recorded table or list will be a text or be converted from text into an electronic document or an image file, which is then sent to a preset individual or several people for reference by email when a specific number of pieces of records is achieved, when a specific time has arrived, or immediately. Therefore, the efficiency in management and use of the communication device can be enhanced.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A method of automatically sending back a communication record by a email, said communication record of a communication device being automatically sent back, said method comprising steps of:
(a) inputting a document transmitted or received by a user;
(b) recording each piece of transmitted or received communication record in an automatic sending back way;
(c) accumulating said each piece of transmitted or received communication record in table or list;
(d) judging whether a specific amount is achieved, whether a specific time has arrived, or whether sending immediately; and
(e) sending said table or list to a preset individual or several people for a reference by a email after receiving a positive answer.

2. The method of automatically sending back the communication record by the email as claimed in claim 1, wherein the automatic sending back way in said step (b) is by a fax, an email, or a file transfer protocol.

3. The method of automatically sending back the communication record by the email as claimed in claim 1, wherein the communication record in said step (b) is a relevant data as a communication serial number, a sender, a receiver, a number of sheets, or a time.

4. The method of automatically sending back the communication record by the email as claimed in claim 1, wherein while said specific amount is not achieved, said specific time has not arrived, or not sending immediately in said step (d), said step (b) is jumped back to.
